(19) United States
(12) Patent Application Publication
(10) Pub. No.: US 2025/0380669 A1
(43) Pub. Date: Dec. 18, 2025

(54) Refillable Feather Toy

(71) Applicant: Anton Kreicbergs, Stockholm (SE)

(72) Inventor: Anton Kreicbergs, Stockholm (SE)

(21) Appl. No.: 19/240,173

(22) Filed: Jun. 17, 2025

Related U.S. Application Data
(60) Provisional application No. 63/661,447, filed on Jun. 18, 2024.

(51) Int. Cl. A01K 15/02

(52) U.S. Cl. CPC A01K 15/025

(57) ABSTRACT

A refillable cat toy features a modular two-piece construction comprising a nut module and a screw module that join via threaded engagement to form a clamping mechanism. The toy securely retains feathers or other play materials using friction without requiring tools. In one embodiment, the toy has a cylindrical or compact form with feather-retaining holes in the nut module and a loop on the screw module for string toy attachment. In another embodiment, the toy includes a mouse-shaped body with an internal threaded cavity and exterior decorative features, such as ears and eyes. Both embodiments allow easy feather replacement by unscrewing the modules, inserting fresh material, and reassembling. The toy accommodates various materials and functions either as a standalone fetch toy or as an attachment to poles or strings. Injection molded for durability, the invention offers an eco-friendly alternative to disposable feather toys by enabling reuse and customization.

### FEDERALLY SPONSORED RESEARCH

Not Applicable

### SEQUENCE LISTING OR PROGRAM

Not Applicable

### TECHNICAL FIELD OF THE INVENTION

The present invention relates generally to cat toys. More particularly, the invention relates to a feather-filled toy that can be bitten and picked up by the cat, as well, and that may be easily refilled by the owner with fresh feathers.

### BACKGROUND OF THE INVENTION

Cats reign as one of the most beloved pets, with a staggering 46.5 million (29%) households in the US alone welcoming one or more into their homes. Just like their canine counterparts require regular walks, cats thrive on playtime. However, the current array of cat toys often falls short, prone to rapid wear and tear or outright breakage. Today's market is saturated with low-quality, inexpensive options, leaving many cat owners seeking sturdier, premium, and eco-friendly alternatives.

Feather toys rank among the most prevalent and favored choices for feline entertainment. Yet, given cats' innate predatory instincts and their arsenal of sharp claws and teeth, these feathered delights often succumb to destruction within mere days. This cycle not only incurs frequent expenses for replacements but also contributes significantly to waste. Traditional feather toys typically comprise plastic, metal, and glue, all of which are discarded once the single-use toy reaches its inevitable demise.

Presently, there are no alternatives to the refillable cat toy of the present invention in the market. The sole refillable/reusable “feather toys” available are string toys, where the entire feather bait at the end of the string must be replaced, resulting in substantial waste.

Considering the extensive prevalence of feather toys for cats currently, the potential for disruption is significant. Embracing the refillable cat toy of the present invention could lead to a substantial environmental impact, marking a considerable shift in the industry.

### SUMMARY OF THE INVENTION

The present invention is a refillable cat toy, offering an innovative solution to address the short lifespan of conventional feather toys. Through a modular and eco-conscious design, the toy securely fastens feathers in place using friction and clamping force between nut and screw modules.

A user-friendly feature allows for easy replacement of worn feathers by simply unscrewing the toy parts/modules, releasing the clamping mechanism, and reassembling the modules. The toy's structure enables robust feather securing within a compact frame, eliminating the need for external tools. Additionally, its versatility extends to doubling as a standalone “fetch” toy and facilitating attachment to string toys through a top cut-out portion in the screw module.

A key aspect of the refillable cat toy taught by the present invention lies in the use of three different holes in the nut module, effectively mimicking popular feather toy designs such as the helicopter and tail-feathers. This design variation enhances the toy's appeal and functionality.

The present invention provides a refillable cat toy characterized by a modular construction that allows secure, tool-free insertion and replacement of feathers or similar materials. The toy comprises a nut module and a screw module that combine via threaded engagement to create a clamping mechanism, holding the inserted material in place through friction. In preferred embodiments, the nut module may be manufactured as a single piece or split into two interlocking halves featuring hook-and-latch protrusion and recess systems, forming a durable snap-fit.

The toy may include three feather-retaining holes arranged to replicate popular feather toy designs, such as “helicopter” and “tail-feather” formats. A top loop or cut-out in the screw module allows attachment to string toys, while the compact and lightweight design also enables standalone play. Additional embodiments include a mouse-shaped housing for enhanced visual appeal. The toy accommodates diverse refill materials and is manufactured via plastic injection molding for durability and reusability.

Beyond feathers, the refillable cat toy accommodates various materials like string, paper, plastic strands, textile, crinkle paper, leather, (faux-/) fur, and textile broadening the scope of play experiences for cats. Manufactured through plastic injection molding, the toy measures approximately 2 cm by 2 cm when assembled and weighs between 3 to 6 grams, depending on the manufacturing material chosen.

The refillable cat toy represents a significant advancement in cat toy technology, offering a sustainable alternative to disposable feather toys. Its modular design and ease of use make it an attractive option for cat owners seeking durable and eco-friendly toys for their pets. With the potential for widespread adoption in the market, the invention promises to disrupt the traditional toy industry while minimizing environmental impact.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a perspective view of a two-piece assembled refillable cat toy taught by the present invention.

FIG. 2 is an expanded/exploded view of the screw module and assembled nut modules of the two-piece cat toy of the present invention.

FIG. 3 is a top perspective view of the top nut module of the two-piece cat toy of the present invention.

FIG. 4 is a bottom perspective view of the top nut module of the two-piece cat toy of the present invention.

FIG. 5 is a top perspective view of the bottom screw module of the two-piece cat toy of the present invention.

FIG. 6 is a bottom perspective view of the bottom screw module of the two-piece cat toy of the present invention.

FIG. 7 is a top perspective view of an assembled three-piece refillable cat toy taught by the present invention.

FIG. 8 is an expanded view of the two-piece nut module of the present invention and the single screw module of a three-piece refillable cat toy taught by the present invention.

FIGS. 9-10 are perspective views of one half of the nut module taught by the three-piece refillable cat toy having a locating and connecting protrusion.

FIG. 11-12 are perspective views of one half of the nut module taught by the three-piece refillable cat toy having a locating and connecting recess.

FIG. 13 is a bottom perspective view of the screw module taught by the three-piece refillable cat toy.

FIG. 14 is a top perspective view of the screw module taught by the three-piece refillable cat toy.

FIG. 15 is a top perspective view of an assembled two-piece refillable cat toy with a mouse shaped body.

FIG. 16 is a bottom perspective view of an assembled two-piece refillable cat toy with a mouse shaped body.

FIG. 17 is an expanded view of a two-piece refillable cat toy with a mouse shaped body.

FIG. 18 is a top view of a two-piece refillable cat toy nut module with a mouse shaped body.

FIG. 19 is a bottom view of the inner structure of the two-piece refillable cat toy nut module with a mouse shaped body.

FIG. 20 is a top perspective view of the screw module of two-piece refillable cat toy with a mouse shaped body.

FIG. 21 is a bottom perspective view of the screw module of two-piece refillable cat toy with a mouse shaped body.

FIG. 22 is a top perspective view of an assembled two-piece refillable cat toy with a mouse shaped body.

FIG. 23 is a bottom perspective view of an assembled two-piece refillable cat toy with a mouse shaped body.

FIG. 24 is a top perspective view of an expanded two-piece refillable cat toy with a mouse shaped body.

FIG. 25 is a top view of the nut module for a two-piece refillable cat toy with a mouse shaped body.

FIG. 26 is bottom perspective view of the inner structure of the nut module of the two-piece refillable cat toy with a mouse shaped body.

FIG. 27 is a bottom perspective view of the screw module of two-piece refillable cat toy with a mouse shaped body.

FIG. 28 is a top perspective view of the screw module of two-piece refillable cat toy with a mouse shaped body.

FIG. 29 is a top perspective view of an assembled two-piece refillable cat toy with a mouse shaped body.

FIG. 30 is a bottom perspective view of an assembled two-piece refillable cat toy with a mouse shaped body.

FIG. 31 is an expanded view of a two-piece refillable cat toy with a mouse shaped body.

FIG. 32 is a top view of a two-piece refillable cat toy nut module with a mouse shaped body.

FIG. 33 is a bottom view of mouse shaped nut module of the two-piece refillable cat toy with a mouse shaped body.

FIG. 34 is a top perspective view of the screw module of two-piece refillable cat toy with a mouse shaped body.

FIG. 35 is a bottom perspective view of the screw module of two-piece refillable cat toy with a mouse shaped body.

FIG. 36 is an expanded perspective view of a two-piece refillable cat toy with a mouse shaped body with feathers.

FIG. 37 is an assembled perspective view of a two-piece refillable cat toy with a mouse shaped body with feathers.

FIG. 38 is an expanded perspective view of a two-piece refillable cat toy and three feathers.

FIG. 39 is an assembled perspective view of a two-piece refillable cat toy with three feathers securely attached.

FIG. 40 is an expanded perspective view of a two-piece refillable cat toy with a single feather.

FIG. 41 is an assembled perspective view of a two-piece refillable cat toy with a single feather securely attached.

FIG. 42 is a perspective view of the assembled two-piece refillable cat toy attached directly to a pole or wand.

FIG. 43 is a perspective view of the two-piece refillable cat toy attached indirectly to a pole or wand using a string.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized, and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known as ordinary skill in the art have not been shown in detail in order not to obscure the invention. Referring to the figures, it is possible to see the various major elements constituting the apparatus of the present invention.

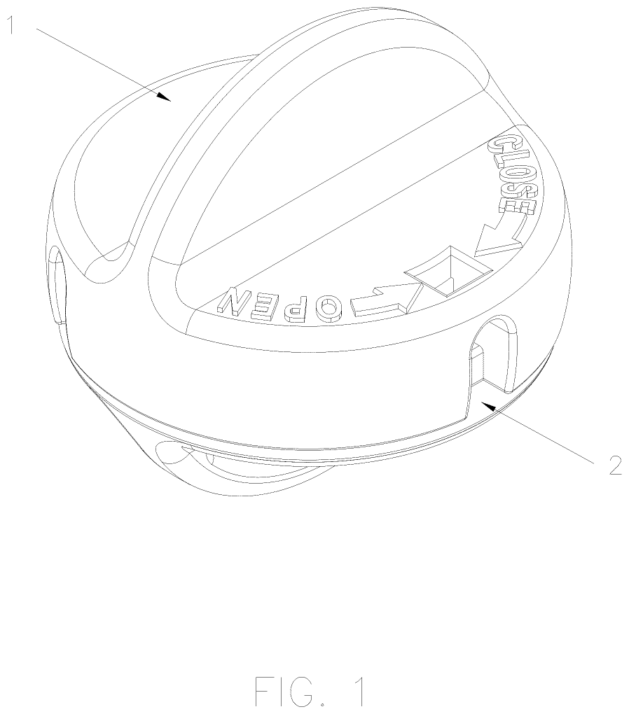

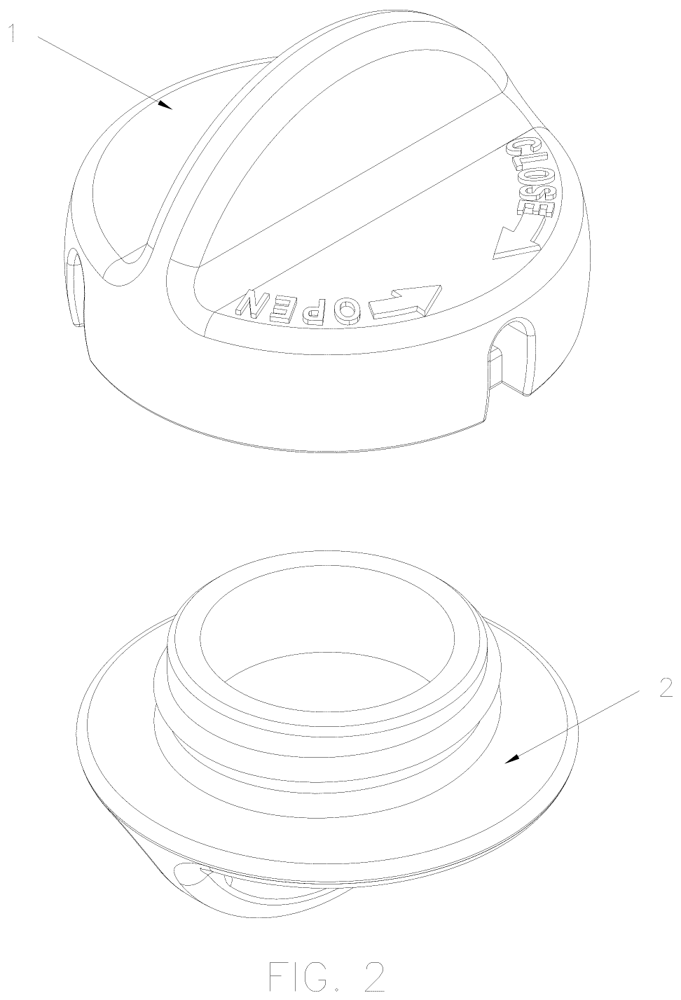

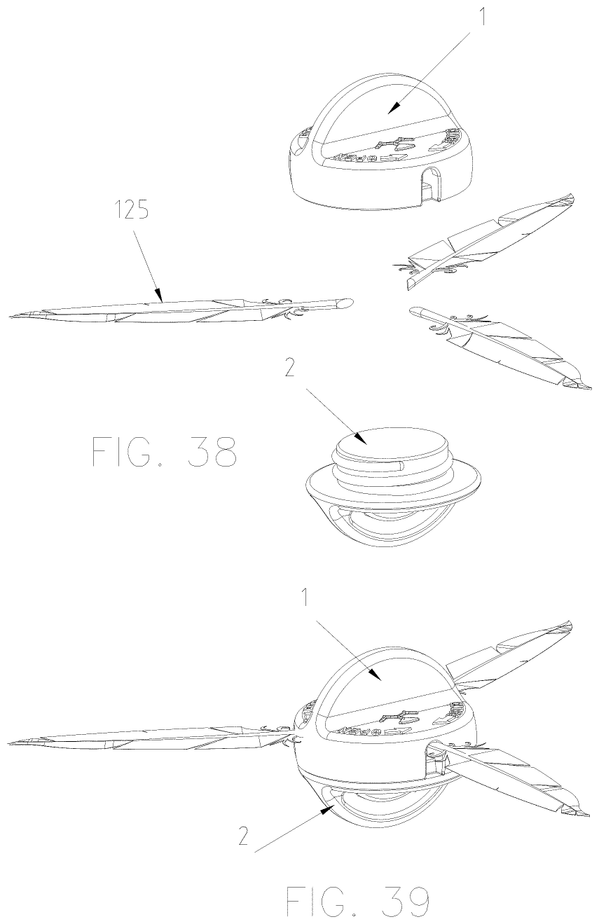

The device of the present invention is a refillable cat toy. FIG. 1 is a perspective view of an assembled refillable cat toy taught by the present invention illustrating a screw module 2 and nut module 1 screwed together in an assembled state. When one or more feathers 125 wear out, a user simply unscrews the refillable cat toy into an expanded or exploded state as illustrated by FIG. 2, releasing the clamping mechanism, replacing the worn feather(s) 125 with one or more fresh feathers 125 as shown in FIGS. 38-41, and finally reassembling the nut 1 and screw 2 modules together into an assembled state as illustrated in FIG. 1.

FIG. 2 is an expanded/exploded view of the screw module 2 and nut module 2 of the present invention. The cat toy taught by the present invention is refillable, modular, and eco-conscious. By harnessing friction and clamping force between nut 1 and screw 2 modules, the cat toy of the present invention securely fastens feathers 125 in place.

FIG. 40 is an expanded perspective view of a two-piece refillable cat toy with one feather 125 securely attached. In this embodiment, one feather 125 is attached to the two-piece refillable cat toy by retaining the feather ends between the nut 1 and screw 2 modules.

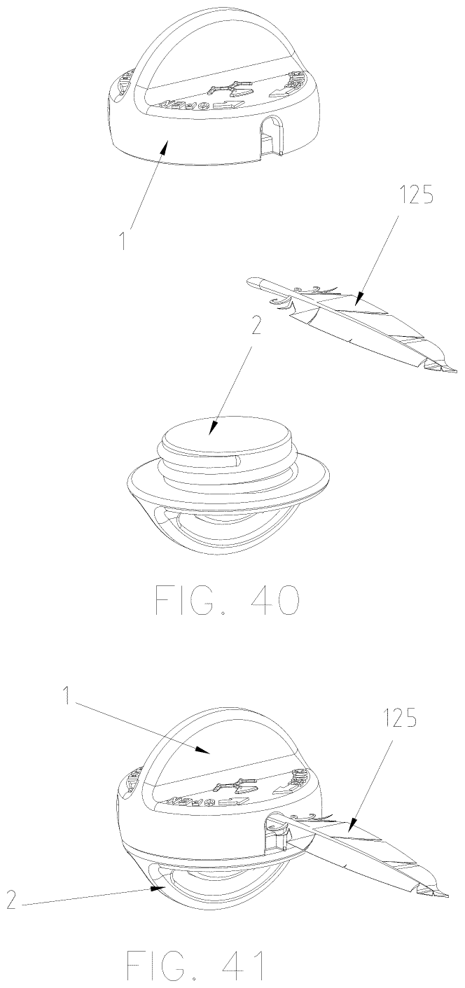

FIG. 41 is an assembled perspective view of a two-piece refillable cat toy with one feather 125 is securely attached. In this embodiment, one feather 125 is attached to the two-piece refillable cat toy by retaining the feather end between nut 1 and screw 2 modules.

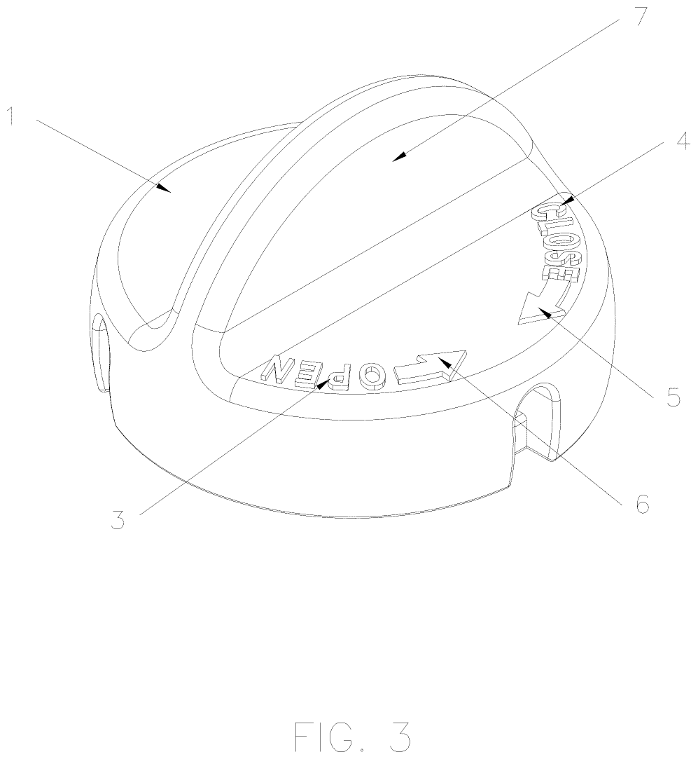

FIG. 3 is a top perspective view of the top nut module 1 of the two-piece cat toy of the present invention. Here the top nut module 1 is comprised of a handle 7 for holding and twisting or turning with respect to the screw module 2. Open 3 and close 4 markers with corresponding arrows 5 and 6.

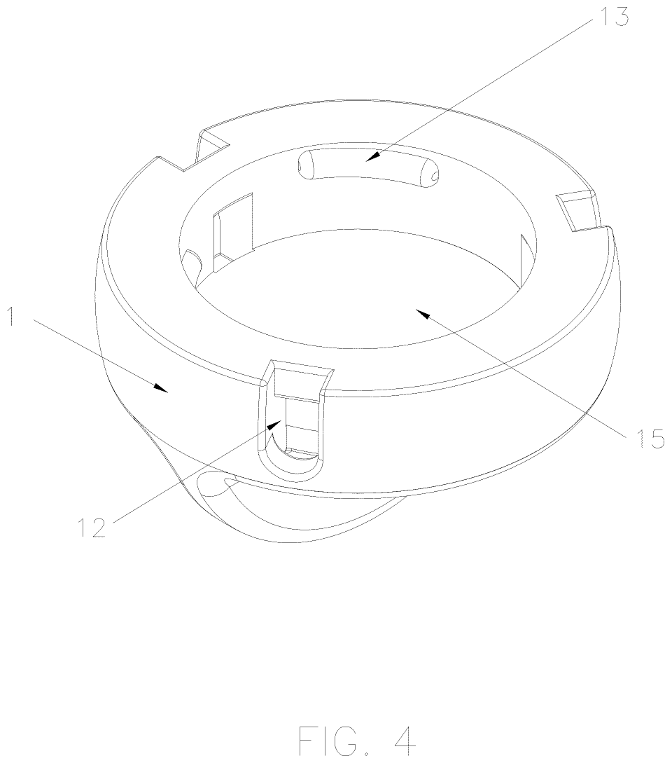

FIG. 4 is a bottom perspective view of the top nut module of the two-piece cat toy of the present invention. The nut module 1 is defined on the bottom or inside by an open space 15 with a bottom that acts as one of the surfaces between which the feather is clamped and securely fastened. The opposing end of the recess 12 defines the openings for a recess creating a channel to secure a feather 125. In some embodiments the open inner space 15 can be filled with catnip or other products.

FIG. 5 is a top perspective view of the bottom screw module 2 of the two-piece cat toy of the present invention. The bottom screw module 2 has a loop handle 16 that allows for easy rotation with respect to the top nut module 1 when screwing them together. The opening 18 can provide an attachment point for tying the cat toy to a pole via a string.

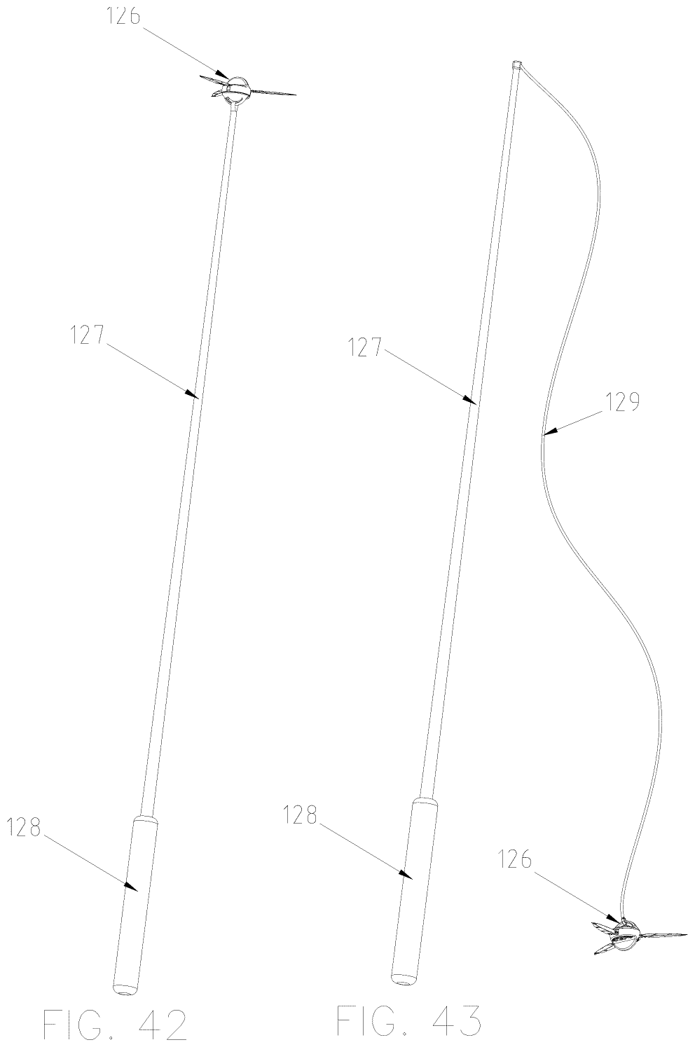

FIG. 42 is a perspective view of the assembled two-piece refillable cat toy 126 attached directly to a pole or wand 127 with a handle 128. In this embodiment, the two-piece refillable cat toy 126, using the opening 18, is attached directly to one end of a pole or wand 127 which has on its opposing end a handle 128 for user grip and comfort.

FIG. 43 is a perspective view of the two-piece refillable cat toy attached indirectly to a pole or wand 127 using a string 129. In this embodiment, the two-piece refillable cat toy 126, using the opening 18, is attached indirectly to one end of a pole or wand 127 by an intervening string 129 which is attached on one end to the opening 18 and on the other opposing end the pole or wand 127, the pole or wand 127 having on its opposing end from that attached to the string 129 a handle 128 for user grip and comfort.

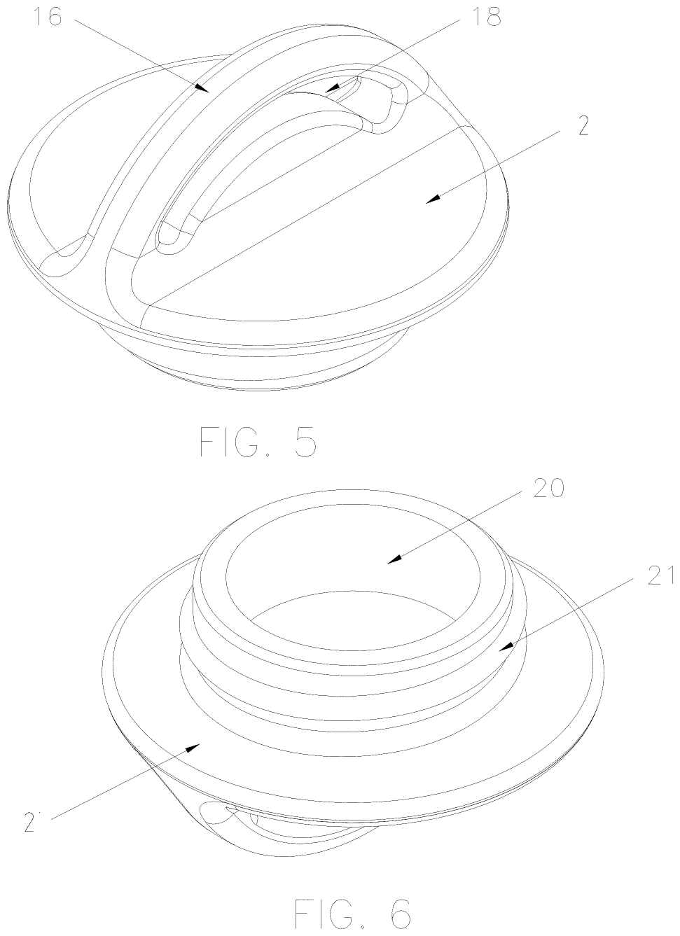

FIG. 6 is a bottom perspective view of the bottom screw module 2 of the two-piece cat toy of the present invention. The bottom screw module 2 has threads 21. The screw module 2 has a recess on an opposite side of the handle 16 which creates an open recess space 20 that corresponds to the open space 15 of the nut module 1.

FIG. 3 is a top perspective view of the nut module 1 of the present invention and FIG. 4 is a bottom perspective view of the nut module 1 of the present invention illustrating the use of one or more holes 12 in the nut module 1 for retaining one or more feathers 125.

In a preferred embodiment, the refillable cat toy of the present invention teaches the use of three different holes 12 in the nut module 1, effectively mimicking two popular feather toy designs: the helicopter and tail feathers 125.

The present invention teaches and enables robust feather securing within a remarkably compact frame, eliminating the necessity for external tools as the screw module 2 and nut module 1 are easily separated by screwing action. Additionally, the refillable cat toy of the present invention doubles as a standalone “fetch” toy for a cat when not attached to a pole or secured in any other manner to limit motion.

The present invention teaches a top cut-out portion of the screw module which facilitates easy attachment to string toys for added versatility. FIG. 5 illustrates the cut-out portion of the top of the screw module. FIG. 3 is a top perspective view of the nut module 1 of the present invention. FIG. 4 is a bottom view of the nut module 1 of the present invention. FIGS. 5-6 are additional planar side views of the screw module of the present invention.

The primary and most intuitive application of the refillable cat toy of the present invention is to substitute disposable feather toys like the helicopter and tail feather varieties. However, the versatility of the refillable cat toy extends beyond feathers 125. Materials such as string, paper, plastic strands, textile, crinkle paper, leather, (faux-/) fur, textile, and other cat-attracting elements can also be inserted and securely fastened onto/into the refillable cat toy for varied play experiences.

FIG. 38 is an expanded perspective view of a two-piece refillable cat toy with three feathers 125 securely attached. In this embodiment, one or more feathers 125 are attached to the two-piece refillable cat toy by retaining the feather ends between nut 1 and screw 2 modules as shown in FIG. 39.

FIG. 39 is an assembled perspective view of a two-piece refillable cat toy with three feathers 125 securely attached. In this embodiment, one or more feathers 125 are attached to the two-piece refillable cat toy by retaining the feather ends between the nut 1 and screw 2 modules.

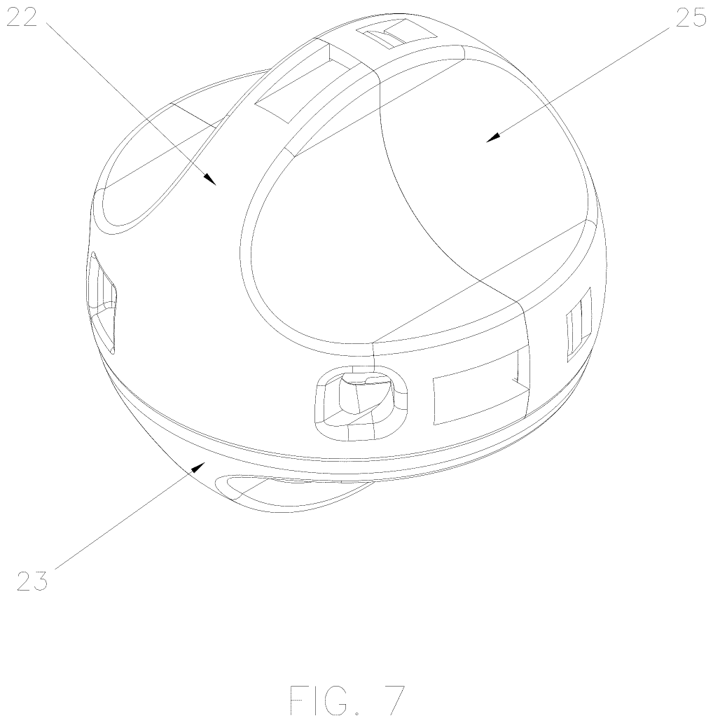

The refillable cat toy of the present invention can be manufactured in either two parts as illustrated by FIGS. 1-6 or three parts as illustrated in FIGS. 7-14 through plastic injection molding.

FIG. 7 is a top perspective view of an assembled three-piece refillable cat toy taught by the present invention comprised of a single bottom screw module 23 and a two-piece top nut module comprised of a two nut body halves 22 and 25.

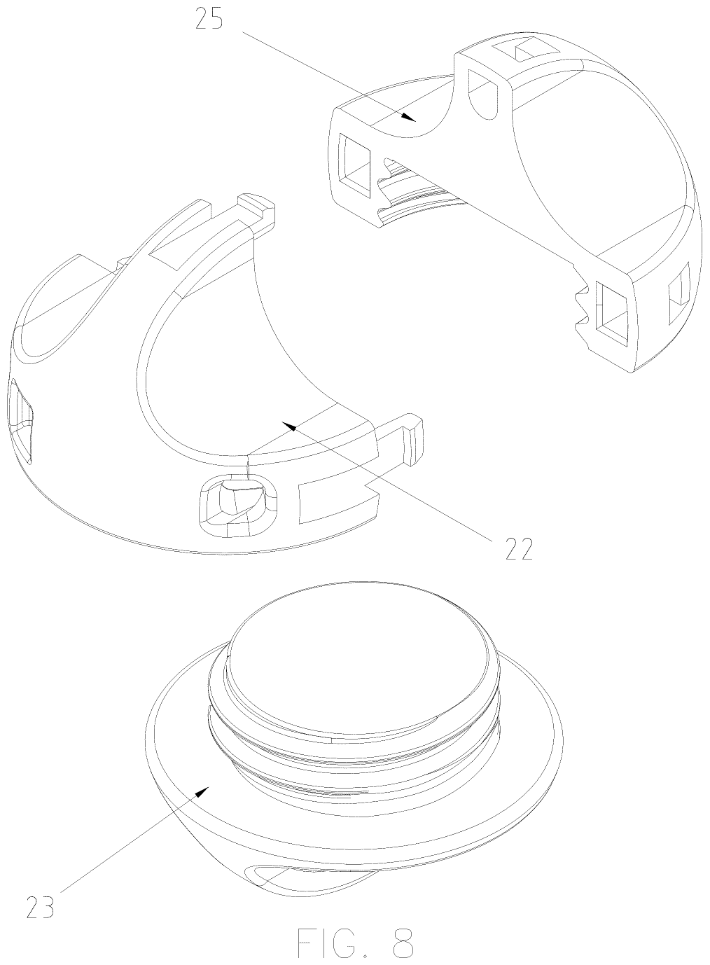

FIG. 8 is an expanded view of the two-piece nut module showing a first nut half 22 and a second nut half 25 of the present invention and the main body of the single screw module 23 of a three-piece refillable cat toy taught by the present invention.

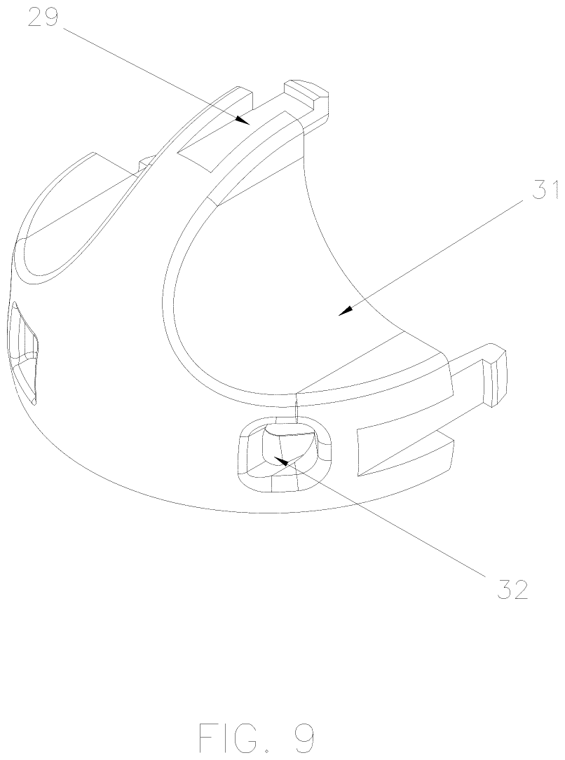

FIGS. 9-10 are top and bottom perspective views of one half of the nut module taught by the present invention having a locating and connecting protrusion 29. The body is shaped and contoured 31 to provide easy grip for turning when assembled. Holes 32 are provided for inserting and securing a feather 125 or other object.

In FIG. 10 side protrusions 34 are shown as well as the threads 33 for receiving a screw and the open area for the screw to enter. A recess provides additional strength to the nut module half 35.

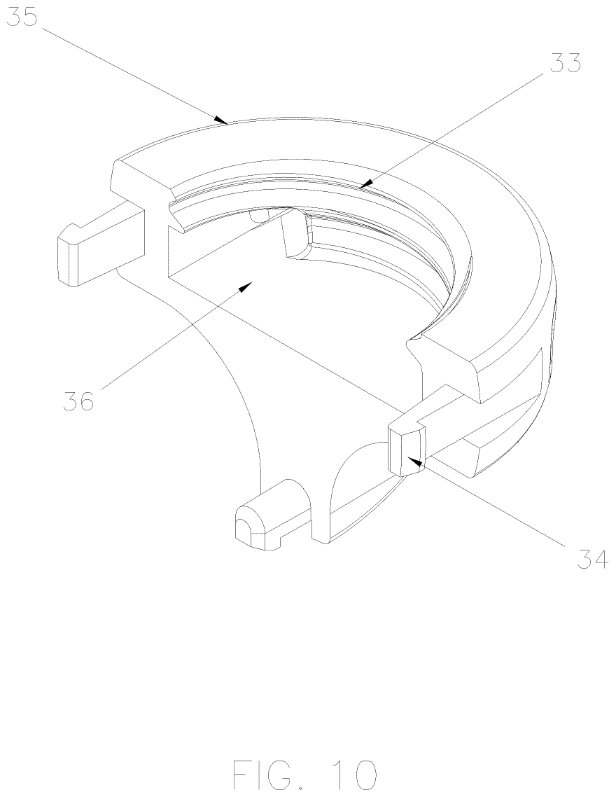

FIG. 11-12 are perspective views of one half of the nut module taught by the three-piece refillable cat toy having a locating and connecting recess. FIG. 11 is a top perspective view of one half of the nut module taught by the present invention having a locating and connecting recess 39 and 42 illustrating how the body is shaped and contoured 43 to provide easy grip for turning when assembled and a strengthening recess. Holes 39 and 44 are provided for inserting and securing the protrusions 34 for the snap fit connection of the two nut module halves.

FIG. 12 is a bottom perspective view of the two-part nut module taught in one embodiment of the present invention. The open space 46 is illustrated adjacent to the threads 45. The body shape and contour 47 are illustrated for creating a handle as well as the holes 40 for securing a feather 125 or other object.

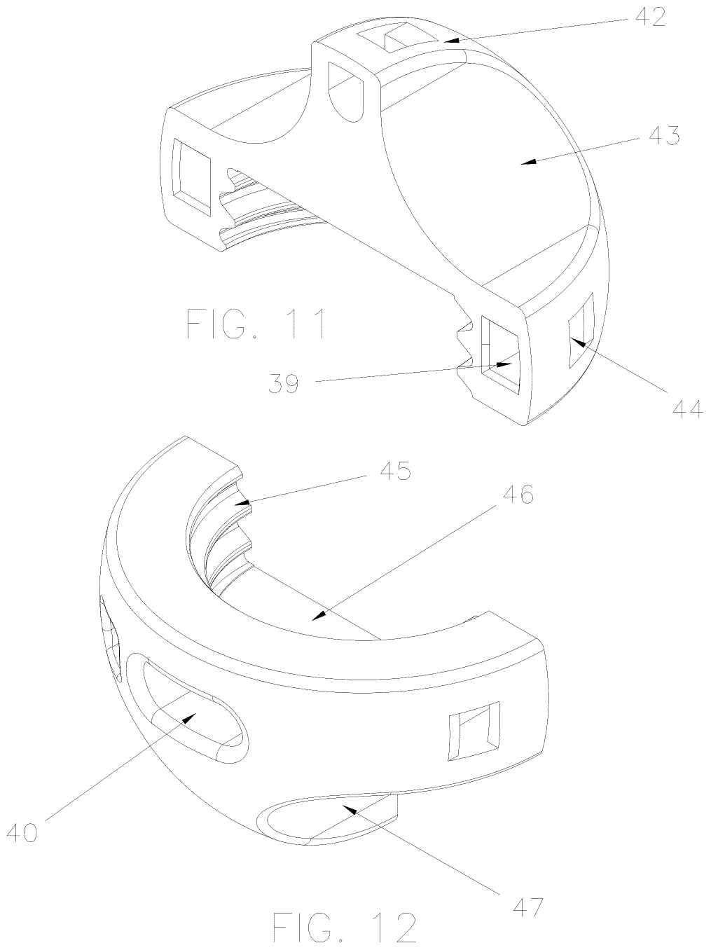

FIG. 13 is a bottom perspective view of the one-piece screw module taught by the three-piece refillable cat toy. The screw module has threads 48 on a protrusion 52 for engaging the nut module and the threads 48 include a recess for securing feathers 125 or other similar objects between the interface surface denoted by the female bottom surface 46 of the inner recess acting as one of the clamping surfaces meant to secure feather and the top surface of the screw 52 acting as one of the clamping surfaces meant to secure feather. Additionally the one-piece screw module has rounding 53 of the main body diameter for strengthening the assembled refillable cat toy.

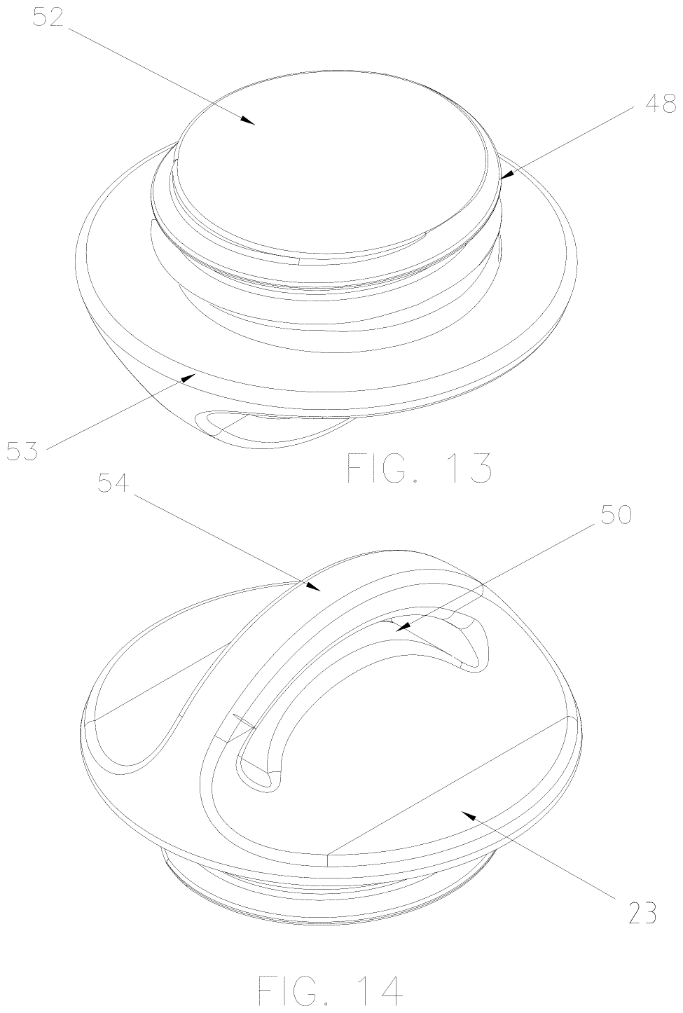

FIG. 14 is a top perspective view of the screw module 23 taught by the three-piece refillable cat toy. Again, a handle 54 is shown as well as an opening 50 for securing the cat toy to a pole or other object via a string.

As illustrated in FIGS. 7-14, when the nut module is manufactured in a two-piece configuration, one half of the nut module is comprised of one or more protrusions, and the other half of the nut module is comprised of a corresponding recess. The protrusions and recesses also have corresponding hook and latch sections so that when they are combined into a single assembly, the hook on the end of the protrusion falls into and is retained by a corresponding hook recess within the recess of the other nut module creating a snap fit.

The refillable cat toy is approximately 2 cm by 2 cm when the screw module and nut modules are screwed together in an assembled orientation and weigh approximately 3-6 grams, depending on manufacturing material. FIG. 8 is an expanded/exploded view of the screw module and two-part nut module of the present invention.

As illustrated in FIGS. 7-14 an alternative embodiment taught by the present invention having multiple locating and connecting protrusion and recesses is illustrated.

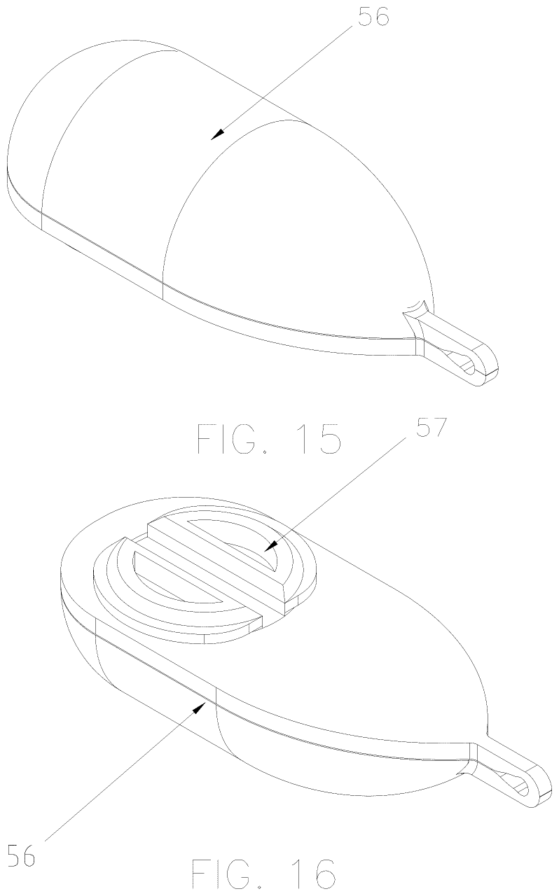

In yet another embodiment of the present invention, FIGS. 15-21 illustrate a two-piece cat toy where the body is shaped like a mouse 56. FIG. 15 is a top perspective view of an assembled two-piece refillable cat toy with a mouse shaped body 56.

FIG. 16 is a bottom perspective view of an assembled two-piece refillable cat toy with a mouse shaped body 56 and a screw module 57.

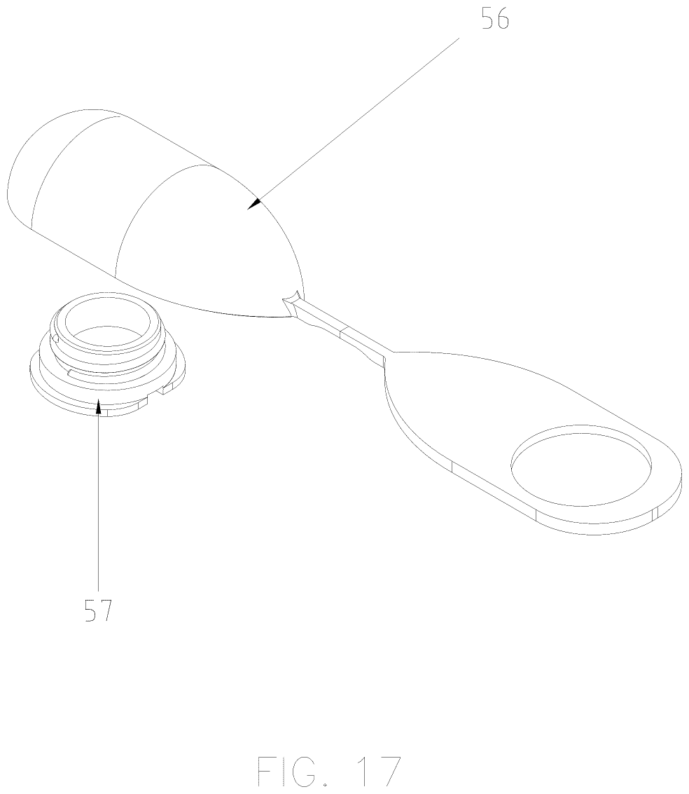

FIG. 17 is an expanded view of a two-piece refillable cat toy with a mouse shaped body 56 with a removable screw module 57. The part sticking out is the bottom of the mouse shaped body, that when folded creates a solid bottom and creates the loop in the front.

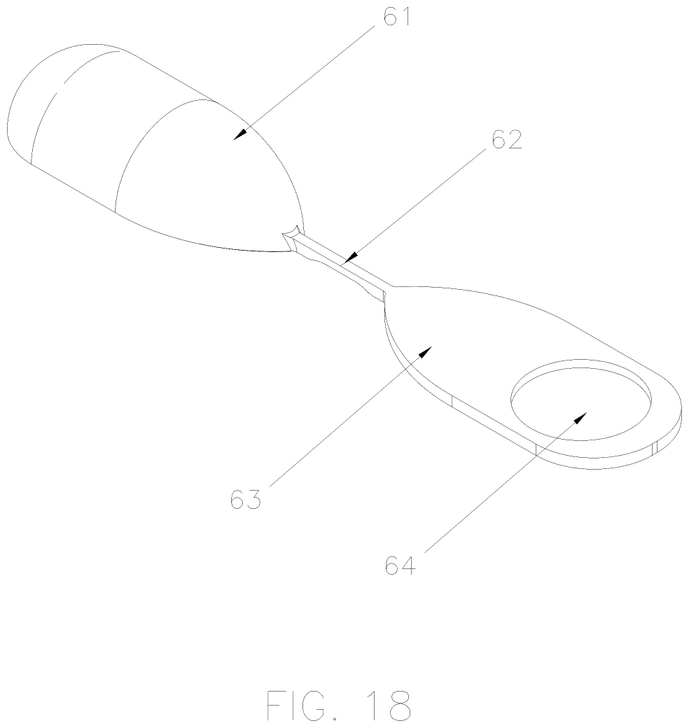

FIG. 18 is top view of a two-piece refillable cat toy nut module with a mouse shaped body having a rear portion and a sloped shaped front or head portion 61 which is then attached by a connector section 62 to a bottom plate 63 which is a solid flat body with an opening 64 for the screw module providing attachment means. The part sticking out is the bottom of the mouse shaped body, that when folded create the solid bottom and created the loop in the front.

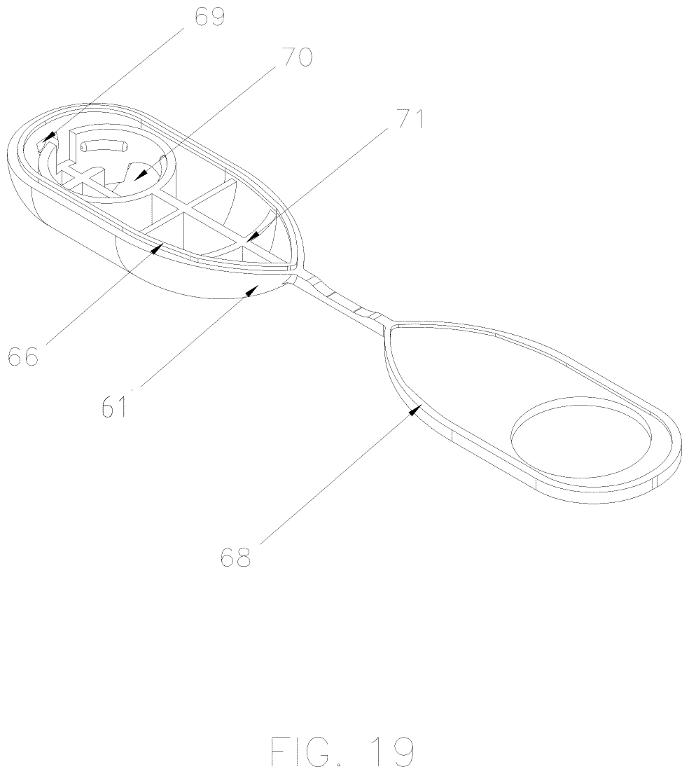

FIG. 19 is a bottom view of the inner structure of the two-piece refillable cat toy nut module with a mouse shaped body 56 and attachment section 68. The interior structure includes strengthening ribs 71 openings 69 for securing feathers 125, a retaining ring or flange 66 for creating an interface with the bottom body, and threads 70 for engaging the screw module.

FIG. 20 is a top perspective view of the screw module 57 of the two-piece refillable cat toy with a mouse shaped body. The screw module 57 has a slot 73 providing a means for screwing the screw module 57 in and out of the mouse shaped body.

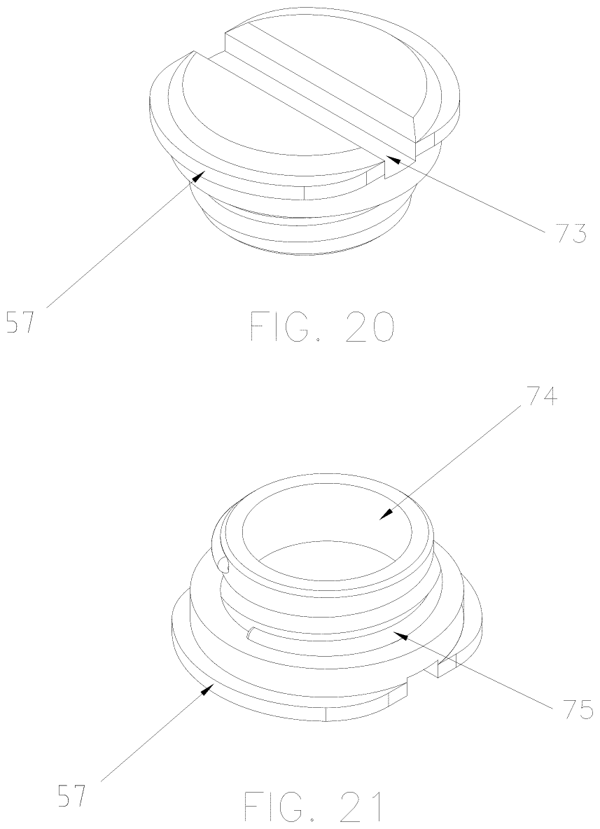

FIG. 21 is a bottom perspective view of the screw module of two-piece refillable cat toy with a mouse shaped body having a hollow screw creating an open space 74, and threads 75 for engaging the mouse body.

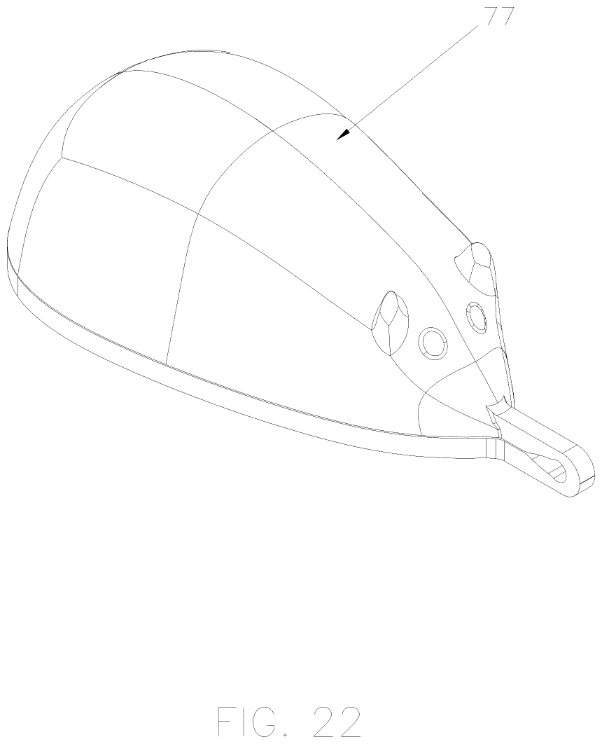

FIG. 22 is a top perspective view of an assembled two-piece refillable cat toy with a mouse shaped body 77.

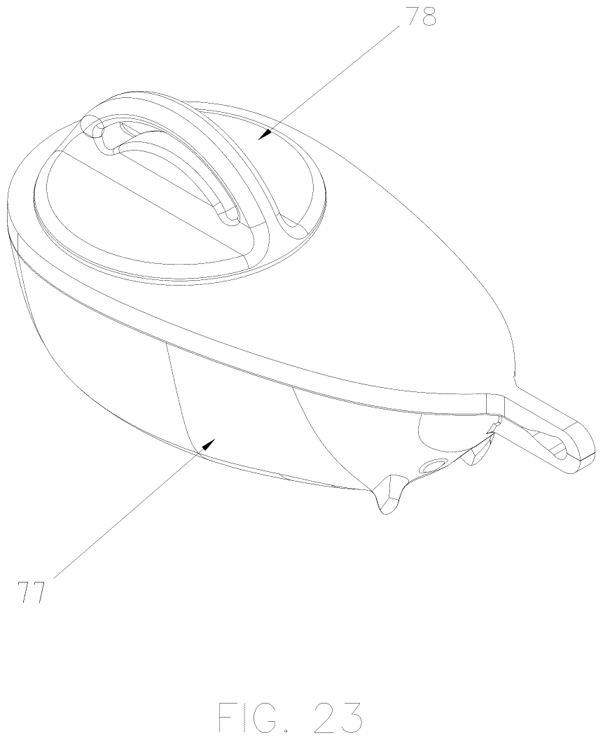

FIG. 23 is a bottom perspective view of an assembled two-piece refillable cat toy with a mouse shaped body 77 and attached screw module 78.

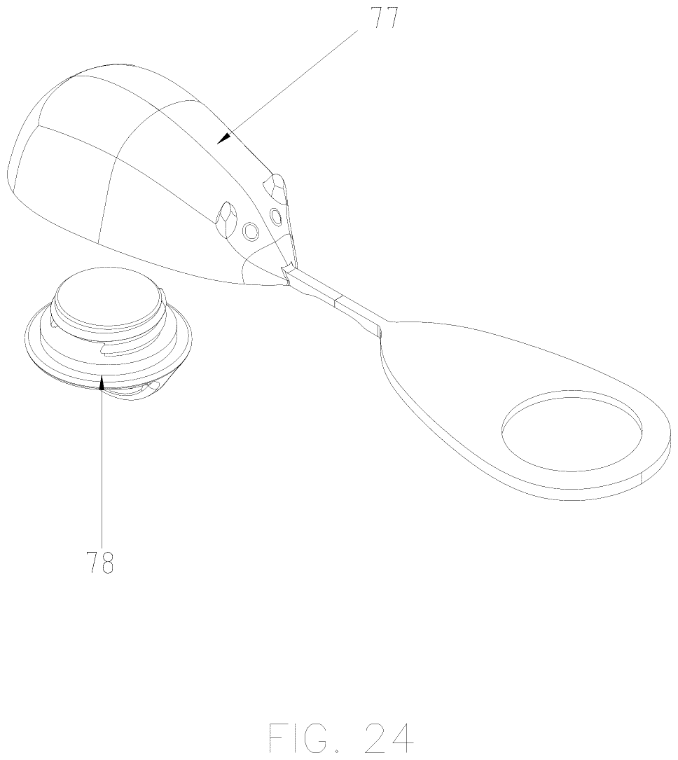

FIG. 24 is a top perspective view of an expanded two-piece refillable cat toy with a mouse shaped body 77 for the screw module 78.

FIG. 25 is a top view of the nut module for a two-piece refillable cat toy with a mouse shaped body 77. In this embodiment, the mouse shaped body 77 is comprised of replica ears 82 and eyes 87. The mouse shaped body 77 is connected to a bottom plate 83 with a loop/hole 84 by a shaft 88.

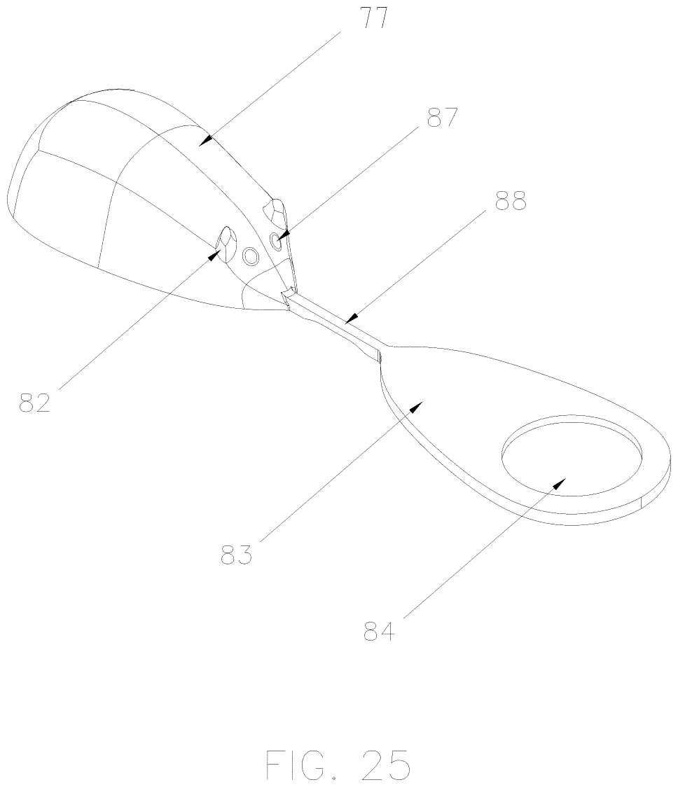

FIG. 26 is bottom perspective view of the inner structure of the nut module of the two-piece refillable cat toy with a mouse shaped body 77. The mouse shaped body 77 has a bottom plate 83, flange 93 (Male part of snap fit for bottom plate) for connecting to the female part of snap fit for bottom plate 95, strengthening ribs 92, a recess 91 providing threads to engage the screw module, and holes 90 for securing a feather 125 and allowing it to protrude from the body 77 which is also attached to the bottom plate 83.

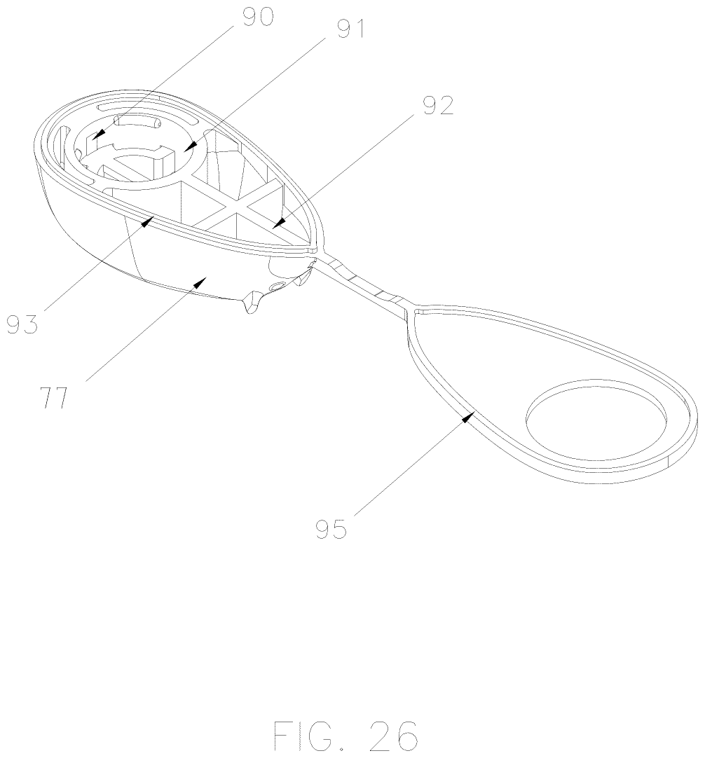

FIG. 27 is a bottom perspective view of the screw module of two-piece refillable cat toy with a mouse shaped body. The screw module has threads 101 on a protrusion for engaging the nut module and the threads include a recess for securing feathers 125 or other similar objects between the top interface surface 100.

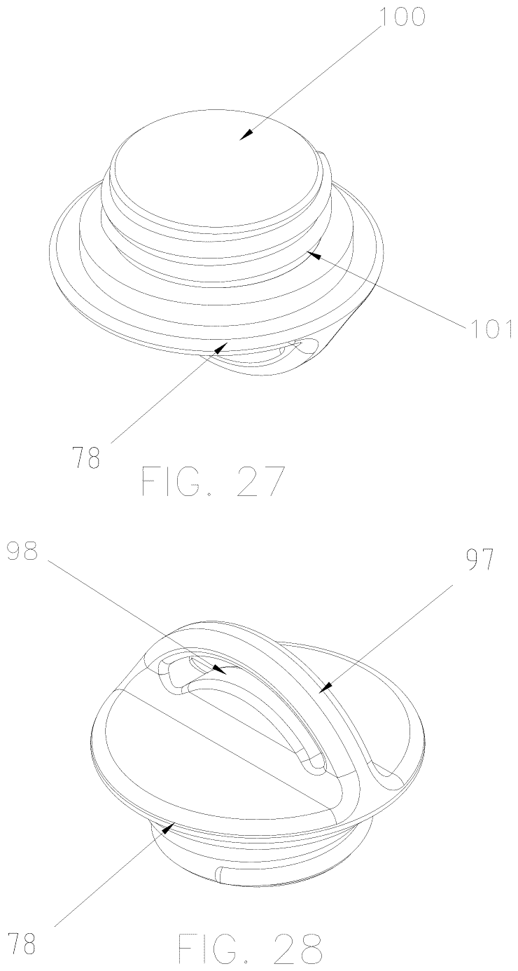

FIG. 28 is a top perspective view of the screw module 78 of a two-piece refillable cat toy with a mouse shaped body. Again, a handle 97 is shown as well as an opening 98 for securing the cat toy to a pole or other object via a string.

FIG. 29 is a top perspective view of an assembled two-piece refillable cat toy with a mouse shaped body 102 and a screw module 104 with handle.

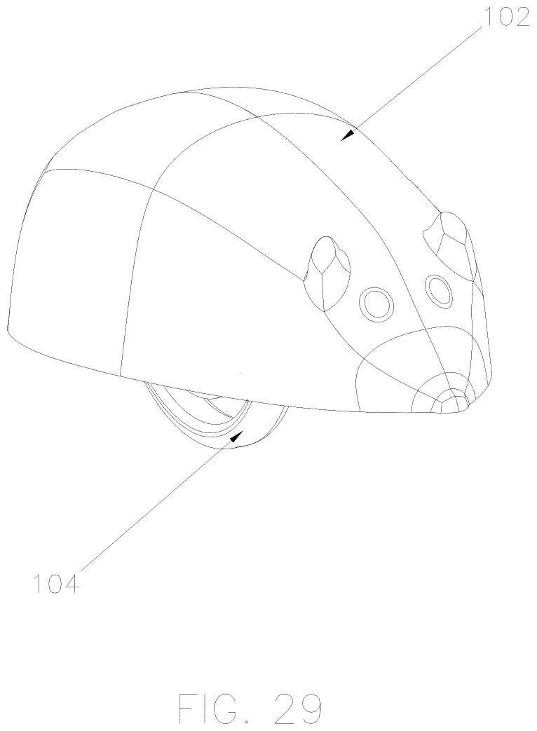

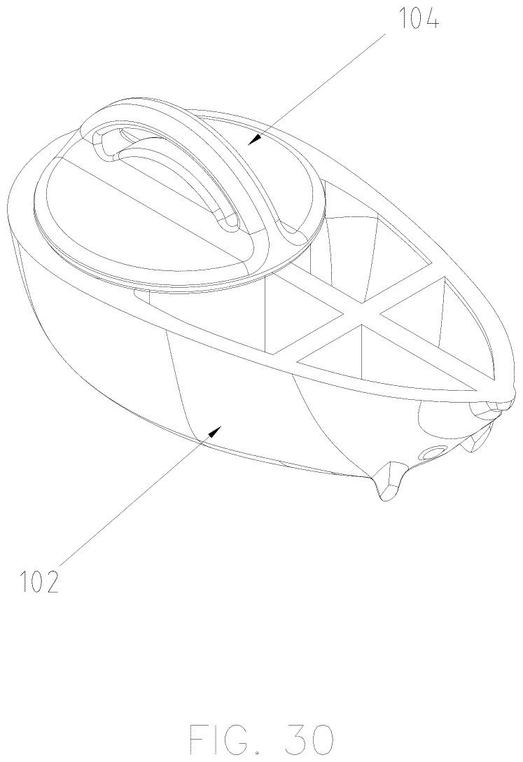

FIG. 30 is a bottom perspective view of an assembled two-piece refillable cat toy with a mouse shaped body 102 and screw module 104 with handle.

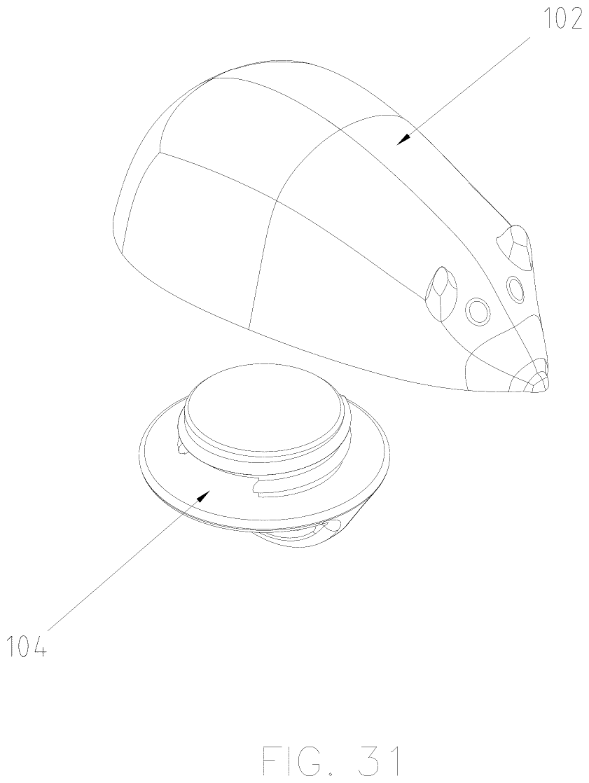

FIG. 31 is an expanded view of a two-piece refillable cat toy with a mouse shaped body 102 separated from the screw module 104.

FIG. 32 is a top view of a two-piece refillable cat toy nut module with a mouse shaped body 102 further illustrating ears 112, eyes 108, and a nose or point 109.

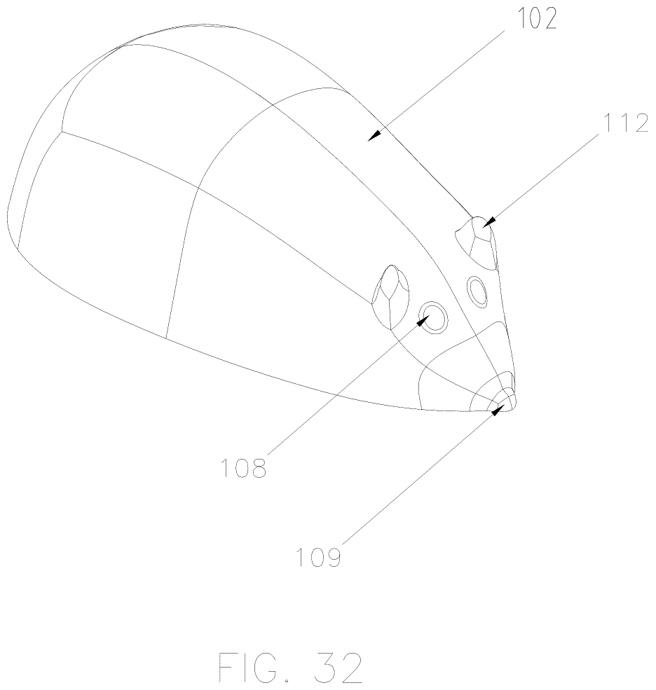

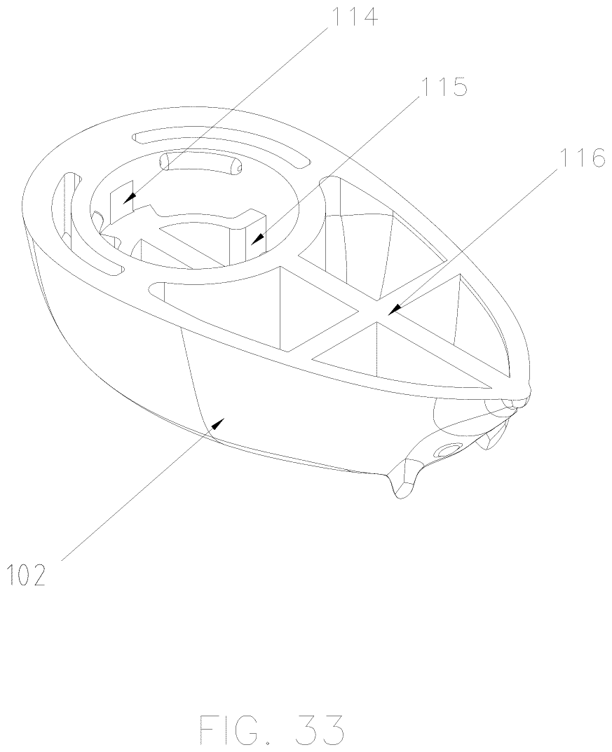

FIG. 33 is a bottom view of mouse shaped nut module of the two-piece refillable cat toy with a mouse shaped body 102 comprising holes 114 creating a channel or tunnel allowing feathers 125 to protrude, strengthening ribs 116 and an internal recess 115.

FIG. 34 is a bottom perspective view of the screw module of two-piece refillable cat toy with a mouse shaped body. The screw module has threads 119 on a protrusion 118 for engaging the nut module and the threads 119 securing or clamping feathers 125 or other similar objects between the interface surface 118 and a rounding of outer edge 122 to increase strength of the design.

FIG. 35 is a top perspective view of the screw module 104 of a two-piece refillable cat toy with a mouse shaped body. Again, a handle 120 is shown as well as an opening 123 for securing the cat toy to a pole or other object via a string.

FIG. 36 is an expanded perspective view of a two-piece refillable cat toy with a mouse shaped body with feathers. In this embodiment, one or more feathers 125 are attached to the mouse shaped body 102 by retaining the feather ends between the mouse shaped body 102 and the screw module 104 secured to the mouse shaped body 102.

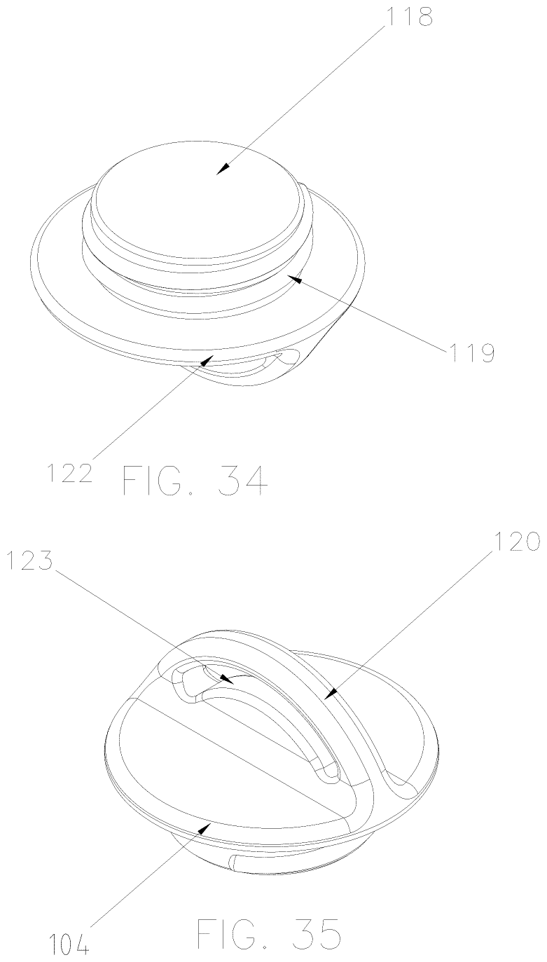

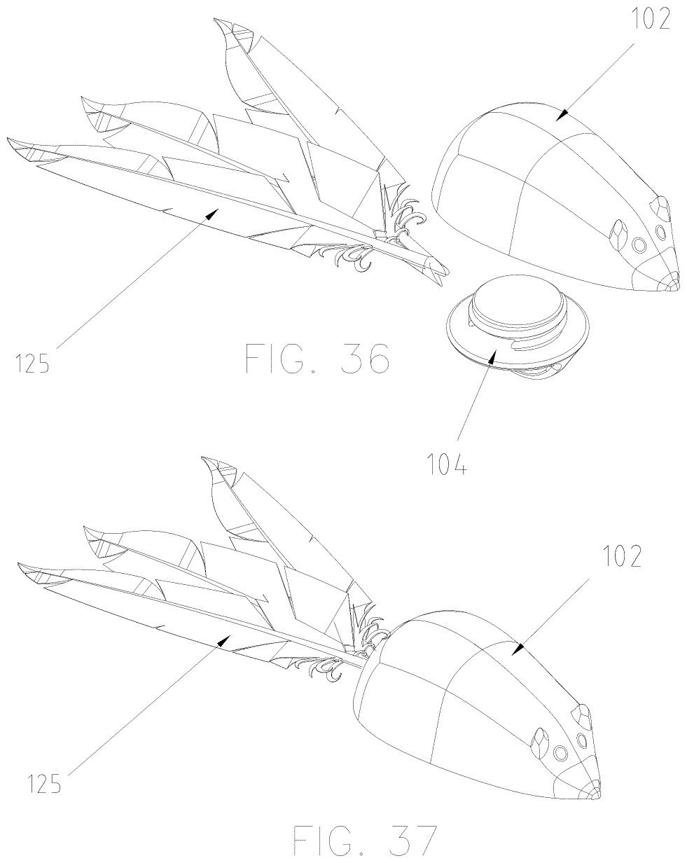

FIG. 37 is an assembled perspective view of a two-piece refillable cat toy with a mouse shaped body 102 where three feathers 125 are attached to one end of the mouse shaped body 102 to represent or replicate a tail.

Thus, it is appreciated that the optimum dimensional relationships for the parts of the invention, to include variation in size, materials, shape, form, function, and manner of operation, assembly, and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A refillable cat toy comprising:
a nut module comprising one or more feather-retaining holes;
a screw module comprising external threads; and
wherein the nut module and the screw module are removably joined by threaded engagement to form a clamping mechanism configured to frictionally secure one or more feathers or other materials inserted through the feather-retaining holes.

2. The refillable cat toy of claim 1, wherein the screw module comprises a top loop or cut-out portion configured for direct attachment to a cat wand or pole.

3. The refillable cat toy of claim 1, wherein the screw module comprises a top loop or cut-out portion configured for indirect attachment to a cat wand or pole via a string.

4. The refillable cat toy of claim 1, wherein the nut module comprises three feather-retaining holes positioned to mimic helicopter and tail-feather toy designs.

5. The refillable cat toy of claim 1, wherein the external threads of the screw module and the recess of the nut combine to secure inserted materials during assembly.

6. The refillable cat toy of claim 1, wherein the nut module includes open and close rotational indicators marked on its outer surface.

7. The refillable cat toy of claim 1, wherein the toy has an assembled size of approximately 2 cm by 2 cm and a weight between 3 and 6 grams.

8. The refillable cat toy of claim 1, wherein the toy is configured to accommodate catnip within an interior cavity of the nut module.

9. The refillable cat toy of claim 1, wherein the nut module and screw module are manufactured by plastic injection molding.

10. The refillable cat toy of claim 1, wherein the inserted material includes one or more of the following: string, plastic strands, textile, crinkle paper, leather, faux fur, or paper.

11. The refillable cat toy of claim 1, wherein the assembled toy is further configured for standalone fetch play independent of a string or pole.

12. A refillable cat toy comprising:
a mouse-shaped body comprising an internal threaded cavity and one or more feather-retaining slots;
a screw module configured with external threads for threaded engagement with the cavity;
wherein the screw module and the mouse-shaped body form a clamping mechanism configured to retain one or more feathers or other materials inserted through the slot.

13. The cat toy of claim 12, wherein the mouse-shaped body includes decorative features selected from ears, eyes, and nose contours.

14. The cat toy of claim 12, wherein the protrusion of the screw and the recess of the nut combine to secure inserted materials during assembly.

15. The cat toy of claim 12, wherein the screw module comprises a handle with a slot or loop for tool-free manual assembly.

16. The cat toy of claim 12, wherein the toy includes one or more feathers positioned to extend from the rear of the mouse-shaped body in a tail-like configuration.

17. The cat toy of claim 12, wherein the assembled toy is further configured for attachment to a pole or wand via a string through the screw module loop.

18. The cat toy of claim 12, wherein the screw module includes a hollow interior for feather or material insertion and compression.

19. The cat toy of claim 12, wherein the assembled toy enables tool-free replacement of feathers by unscrewing the screw module from the mouse-shaped body.

20. The cat toy of claim 12, wherein the mouse-shaped body is sized and weighted to function as a standalone play object in addition to a string toy attachment.
